(19) United States
(12) Patent Application Publication
(10) Pub. No.: US 2018/0238303 A1
(43) Pub. Date: Aug. 23, 2018

(54) METHOD FOR OPERATING A WIND FARM

(71) Applicant: Wobben Properties GmbH, Aurich (DE)

(72) Inventors: Wolfgang DE BOER, Moormerland (DE); Tim MÜLLER, Niederkassel (DE); Harro HARMS, Wiesmoor (DE)

(73) Assignee: Wobben Properties GmbH, Aurich (DE)

(21) Appl. No.: 15/755,501

(22) PCT Filed: Sep. 7, 2016
(86) PCT No.: PCT/EP2016/071028

§ 371 Date: Feb. 26, 2018

(30) Foreign Application Priority Data
Sep. 7, 2015 (DE) 10 2015 114 958.3

(51) Int. Cl. F03D 7/04; F03D 7/02

(52) U.S. Cl. CPC F03D 7/048; F05B 2270/333; F05B 2270/329; F03D 7/0204

(57) ABSTRACT

A method for operating a wind farm with a number of wind power installations is provided. Each wind power installation respectively has a nacelle with an aerodynamic rotor with one or more rotor blades and a generator. Each of the wind power installations is variable in its azimuth position and at least two of the wind power installations are so close together that, depending on the direction of the wind, they can influence one another by way of the wind. At least a first of the wind power installations is cut back in dependence on its azimuth position in order to positively influence the wind for a further wind power installation arranged downwind of the first.

### BACKGROUND

### Technical Field

The present invention relates to a method for operating a wind farm and relates to a wind farm.

### Description of the Related Art

Wind farms are known and comprise a number of wind power installations; at least two but usually many more. In such cases the wind power installations usually feed their power into the electrical supply grid by way of a common grid connection point of the farm. Particularly in such wind farms there may be a situation in which at least two wind power installations are so close together that one wind power installation influences the other by way of the wind. Particularly there may be a situation in which one wind power installation is downwind of another when the wind is in a certain direction, that is to say is on the leeward side of the other. As a result, such a downwind, leeward wind power installation may possibly be exposed to weaker wind and/or more turbulent wind. That can have the effect, in particular, that this downwind wind power installation can then generate less power. This phenomenon is also referred to as the wake effect.

This problem is known in principle, and it would usually be disproportionate to set the wind power installations so far apart that such effects do not occur at all because this would mean that considerable space in which the wind power installations could be set up would be unused.

It can be problematic in this respect that the two wind power installations mentioned by way of example are operated by different operators. It is then not only a matter of how much power the wind farm as a whole can feed into the grid, but which installation specifically is affected by such a wake effect. Here it particularly comes into consideration that one of the two wind power installations was set up later, and consequently the other is entitled to a certain right of continuance. If this older wind power installation is then on the leeward side after the new construction of the other, newer wind power installation and is generating less power, this is correspondingly undesired for this operator of the older wind power installation.

However, other cases in which it is undesired that the downwind wind power installation, that is to say the wind power installation on the leeward side, is influenced by the upwind installation, also come into consideration. Particularly, the upwind wind power installation may also cause turbulence, which may not only reduce the power of the downwind wind power installation on the leeward side but also lead to undesired additional mechanical loading. It may, for example, be the case that said wind power installation on the leeward side generates less power than would be possible on the basis of the prevailing wind speed, and nevertheless is exposed to a high wind loading due to the turbulence mentioned. In this case, at least the loading would be in an unfavorable ratio to the power generation.

In order to solve these problems, it has already been proposed to shut down such a wind power installation on the windward side, in order not to adversely influence the wind power installation downwind from it on the leeward side; in particular, not to expose it to the turbulence of the wind speed that would otherwise be produced by this installation on the windward side.

Although such a situation uncommonly occurs, such a shut-down would of course be undesired for the operator of the installation that is to be shut down.

The German Patent and Trademark Office has searched the following prior art in the priority application relating to the present application: GB 2 481 461 A, US 2011/0208483 A1, US 2012/0133138 A1, US 2013/0156577 A1, EP 2 063 108 A2 and WO 2015/039665 A1.

### BRIEF SUMMARY

At least one of the disadvantages explained above are addressed herein. In particular, a solution that takes into consideration the wake effect mentioned, but nevertheless is intended to avoid shutting down the respectively upwind wind power installation on the windward side is proposed.

A according to a method provided herein each wind power installation respectively has a nacelle with an aerodynamic rotor with one or more blades and also a generator. Each of these wind power installations is variable in its azimuth position, where at least two of the wind power installations are so close together that, depending on the direction of the wind, they can influence one another by way of the wind. At least a first of the wind power installations is cut back in dependence on its azimuth position in order to positively influence the wind for a further wind power installation arranged downwind of the first.

The wind farm that is operated by this method consequently has a number of wind power installations which respectively have a nacelle and a generator. Each wind power installation is variable in its azimuth position; that is to say in its alignment in relation to the wind. Furthermore, at least two of the wind power installations are so close together that, depending on the direction of the wind, they can influence one another by way of the wind. Influencing, therefore, occurs in particular whenever, when seen in the direction of the wind, a first of the wind power installations is upwind of the other. The first wind power installation is consequently on the windward side and the other on the leeward side. The influencing may depend on various factors. It can in any event be assumed that at least the first influences the one downwind of it if the distance between these two wind power installations is less than ten times, in particular less than five times, the height of the tower of the first wind power installation.

It is, thus, proposed that this at least one first wind power installation is cut back in dependence on its azimuth position in order to positively influence the wind for the downwind wind power installation. This should also be understood in particular as meaning that the wind is not adversely influenced, or not less adversely influenced, than would be the case without cutting back. The cutting back, therefore, improves the wind situation for the following installation in comparison with the situation if first installation were not cut back, without the need for it to be shut down.

It is consequently proposed that the first wind power installation continues to be operated, but undergoes a reduction in its operation. The wind power installation is, therefore, not stopped or shut down.

In particular, the cutting back is performed in such a way that an operational change is made. This includes the possibilities of reducing the generator output, prescribing a maximum generator output, reducing the rotor speed, increasing the blade angle and in addition or as an alternative prescribing a minimum blade angle.

By reducing the generator output, the wind power installation is also set as a whole to this reduced power, and correspondingly less power is also taken from the wind and the wind is consequently influenced to a lesser extent. As a result, the wind is reduced less by this first installation for the installation downwind of it. In addition or as an alternative, the wind undergoes less turbulence.

Reducing the generator output can be carried out in real time in dependence on the existing situation by a corresponding default value. One possibility is also that of prescribing a maximum generator output. As a result, the generator is controlled on the basis of this maximum generator output, and correspondingly a lower generator output cannot be set. Such a default is particularly advisable whenever there can be other control interventions with an effect on the generator output, such as, for example, cutting back this first wind power installation in its power on the basis of a prescribed noise reduction. By setting this default of a maximum value, conflicts can be avoided, by simply using the smallest value for controlling or cutting back whenever there are different power limits for various reasons. A conflict of different desired power values can in this way be avoided.

Another or additional possibility for cutting back is to reduce the rotor speed. Particularly the rotor speed can have a considerable influence on the wind for a wind power installation arranged downwind of this first installation. Here, too, a maximum rotor speed may be prescribed. An advantage over a directly prescribed rotor speed is obtained by avoiding a conflict between a number of default speed values in a way analogous to that explained in relation to prescribing a maximum generator output. Furthermore, and this once again also applies to prescribing a maximum generator output, here, too, a fixed value can be prescribed in dependence on the azimuth position that is taken as a basis for cutting back, and this is also the value when the installation still first has to start up. These values are then already available and can be easily taken into account.

In addition or as an alternative, the cutting back may be performed by increasing a blade angle. In particular, this blade angle is increased equally for all of the rotor blades of the wind power installation. For this first wind power installation, which is being reduced here, this may act in the same way as reducing the wind speed. Increasing the blade angle can to this extent be seen as a worsening of the angle of attack of the blade, so that less power is taken from the wind, and correspondingly the wind is also influenced less for the following wind power installation; in particular is reduced less and/or undergoes less turbulence.

Also for using the blade angle as a possibility for cutting back, it is proposed to prescribe a minimum blade angle. In this case, increasing the blade angle is understood as meaning adjusting the blade in the direction of a feathered position. When an angle is set as a fixed value in the partial load operating range, on the other hand, there is a very small angle of between 1 and 10°. In particular, such a small angle, to be specific an optimum angle, may be 5°.

By prescribing a minimum blade angle, here, too, it is possible to counter any conflict if, for some other reason, a blade angle increase should also be desired. Here, too, different minimum blade angles may be prescribed, and these different default values can be taken into account by the greatest of these minimum blade angles being selected as a lower limit.

A combination of the possibilities for cutting back that have been mentioned is also possible. Particularly, a reduction in power and/or a reduction in rotational speed can also be achieved by adjusting the blade angle, to name just one example.

According to one embodiment, it is proposed that, for cutting back in dependence on the azimuth position, an azimuth sector is prescribed, so that the cutting back is performed when the wind power installation has an azimuth position within the prescribed azimuth sector. Checking the azimuth position, which is a prerequisite for cutting back, can consequently be easily implemented by prescribing such an azimuth sector. By prescribing such an azimuth sector, the specific conditions can also be taken into account, in particular the azimuth sector may vary in size depending on the distance between the first wind power installation and the downwind wind power installation. Correspondingly, an azimuth sector of a corresponding size can be selected.

It is preferably proposed for this that the cutting back is only discontinued after a predetermined delay time once a criterion for cutting back is no longer applicable. This is particularly advantageous also for cutting back in dependence on an azimuth sector. If the wind power installation, that is to say the nacelle, in its position leaves the azimuth sector, the cutting back is not discontinued immediately, but first the predetermined delay time is allowed to elapse. If in this time the nacelle moves back again into the azimuth sector, the wind power installation can continue to be operated in the cut-back mode. In this way it is possible to avoid continual cutting back and discontinuation of the cutting back when the nacelle is in a region of a limit of an azimuth sector.

According to one embodiment, it is proposed in principle that, in addition to depending on the azimuth position, the cutting back is also performed depending on the wind speed. Both when there are very low wind speeds and when there are very high wind speeds, it is possible to dispense with cutting back or for it to be lessened. When there are very low wind speeds, the influence of the first wind power installation, that is to say the wind power installation on the windward side, on the installation downwind of it may be very small, so that cutting back may be not necessary or not as necessary. When there are particularly high wind speeds, particularly above a nominal wind speed, although there may be a considerable weakening of the wind for the following wind power installation, it nevertheless produces a wind on the downwind side that is above the nominal wind speed, and to this extent the downwind wind power installation on the leeward side is still exposed to nominal wind and correspondingly can be operated with nominal power.

It is also proposed for this criterion to discontinue the cutting back only after a predetermined delay time when this criterion is no longer applicable. If the wind speed therefore increases to such a high value that cutting back no longer needs to be performed, according to this embodiment the predetermined delay time is nevertheless allowed to elapse before cutting back is actually discontinued. A similar procedure is also proposed if the wind speed assumes such a great value that for this reason there is no longer any need for cutting back. Also then, according to one embodiment, it is proposed first to allow a predetermined delay time to elapse and only then to cut back if in the meantime the wind speed has not fallen again too much.

These are a number of examples of allowing a predetermined delay time to elapse once a criterion for cutting back is no longer applicable. However, in principle still further criteria for cutting back may also be taken into account, and for these it may also be advantageous first to allow a predetermined delay time to elapse before cutting back is discontinued again.

According to a further refinement, it is proposed that the cutting back is carried out in dependence on at least one further criterion, to be specific depending on the wind speed, as already explained above, and/or alternatively depending on other wind conditions, such as for example gusty conditions.

For example, when there are very gusty conditions, in particular when a comparatively great number of gusts occur, such as, for example five gusts per minute, cutting back cannot be performed. This would take into account that less laminar flows occur in very gusty wind, and consequently the first wind power installation, which is on the windward side, influences and changes the wind for the following installation on the leeward side to a lesser extent.

It is consequently proposed to include gusty conditions, and also, or alternatively, a gusting frequency of the prevailing wind in the method. One possible definition of a gust would be when the measured 1-minute mean value of the wind speed is exceeded by at least 3 m/s within a few seconds, for, example a maximum of 20 seconds, and lasts for at least 3 seconds. A gust may also be identified by way of a comparison of the current wind speed with a 10-minute mean, it being possible for it to be considered to be a gust when the wind exceeds a lower value, for example in the range of 1.7 m/s. A gust can correspondingly be registered, and it is in this way also possible to count gusts, and consequently to determine their frequency, that is to say occurrence over an interval of time.

According to one embodiment, it is proposed to change the azimuth sector depending on gusty conditions, and also or alternatively depending on a detected discontinuity in the direction of the wind. Here, the azimuth sector is preferably increased.

In a further embodiment, it is proposed that at least the first wind power installation has a number of prescribed azimuth sectors at which cutting back is performed. This allows account to be taken of different wind directions, which result in different wind power installations being downwind, that is to say on the leeward side, with respect to this first wind power installation. In this case, these azimuth sectors may be of different sizes and also lead to this first wind power installation behaving differently, in particular behaving differently in terms of cutting back. Azimuth sectors may also overlap.

If, for example, two azimuth sectors are provided, leading to different minimum blade angles, in this way different cutting back can be achieved in the two sectors. If these two sectors overlap, a conflict in this overlapping region can be avoided by prescribing a minimum blade angle in each case, because the greatest of this minimum blade angle is chosen, and consequently also the smaller minimum blade angle is maintained. This is to this extent only a specific example.

The cutting back in dependence on the azimuth position or in dependence on the azimuth sector is preferably carried out in such a way that the further wind power installation arranged downwind of the first wind power installation, that is to say the installation on the leeward side, is exposed to more wind power than without cutting back the first wind power installation. For this purpose, it is proposed in particular that the cutting back is not carried out, or is carried out to a lesser extent, when the wind power installation downwind of the first wind power installation, that is to say the wind power installation on the leeward side, is operating in a throttled mode.

This is based on the realization that in some cases it is possible to dispense with cutting back. By cutting back the wind power installation on the windward side, the wind power installation on the leeward side is exposed to more wind than in the case where cutting back is not carried out. If, however, the wind power installation on the leeward side is in a throttled mode, it in any case already generates less power. It was realized that in this case cutting back the wind power installation on the windward side may be unnecessary.

The throttled mode often also leads to misaligned rotor blades, which are at least slightly turned out of the wind, and, therefore, are also less susceptible to turbulence that could be produced by the wind power installation on the windward side.

Such cutting back is preferably not carried out, or is carried out to a lesser extent, when the wind power installation downwind of the first wind power installation, that is to say the wind power installation on the leeward side, is operating in a reduced-noise mode. Such a reduced-noise mode may be provided, for example, in order not to disturb residents in the vicinity of the wind power installation. In this case, such a reduced-noise mode may be provided in a wind farm just for one wind power installation or for a number of wind power installations, but not necessarily for all the wind power installations. The reduced-noise mode depends on many boundary conditions, in particular how close the wind power installation concerned is to a resident, to continue with this example. It may therefore come into consideration for example that the one wind power installation operates in a reduced-noise mode, in particular as a result operates in a reduced-power mode, that is to say generates less power than would be possible on the basis of the wind conditions. In this case, the wind power installation upwind of it, that is to say the wind power installation on the windward side, does not need to cut back, or not cut back to such an extent.

According to one embodiment, it is proposed that the cutting back is carried out with a gradient. This concerns, in particular, the first wind power installation, when it changes from a no cut-back state to a state in which cutting back is to be performed. Then, for example, a value for a maximum generator output is prescribed and/or a value for a maximum rotor speed is prescribed and/or a value for a minimum blade angle is prescribed. However, the installation does not switch over to this new operating state, assuming here that it is operating at the time above this maximum generator output or above the maximum rotor speed or below this minimum blade angle, but instead goes to such a new operating point in a controlled manner with at least one gradient. If a number of the operational changes mentioned are carried out, it is also possible for different gradients to be provided.

This has not only the aim of relieving the controller of the installation as such, but, for example, also of avoiding an abrupt adjustment of the rotor blades. A resultant reduction in the power could particularly also have an undesired effect on the electrical supply grid it is feeding into, which is avoided or reduced by use of one or more gradients.

Provided is a wind power installation that is configured for being operated in a wind farm, the wind farm being operated by a method according to at least one of the embodiments explained above and the wind power installation being cut back in dependence on its azimuth position, in order to positively influence the wind for a further wind power installation arranged downwind of it. Such a wind power installation is consequently configured to operate in such a way that, by cutting back, it can achieve the effect for a wind power installation downwind of it that this wind power installation downwind of it does not undergo any loss in power, or at most a small loss, as a result of this first wind power installation.

Provided is a wind farm that has at least one wind power installation as described above. In this case, a wind farm is a collection of a number of wind power installations that feed into a supply grid, in particular by way of a common grid connection point. An advantageous operating behavior of the wind power installations in this farm is provided. What is concerned here is the mutual influencing of the wind power installations by way of the wind; when the wind is in one direction, this mutual influencing usually only concerning the influence of the first wind power installation on the second, downwind of it, rarely vice versa.

On the basis of these wind-related interrelationships, a wind power installation may also satisfy the criteria with respect to a further wind power installation, in particular perform a method, without these two wind power installations necessarily feeding in by way of the same grid connection point.

### BRIEF SUMMARY

The invention is explained below in more detail on the basis of exemplary embodiments by way of example with reference to the accompanying figures.

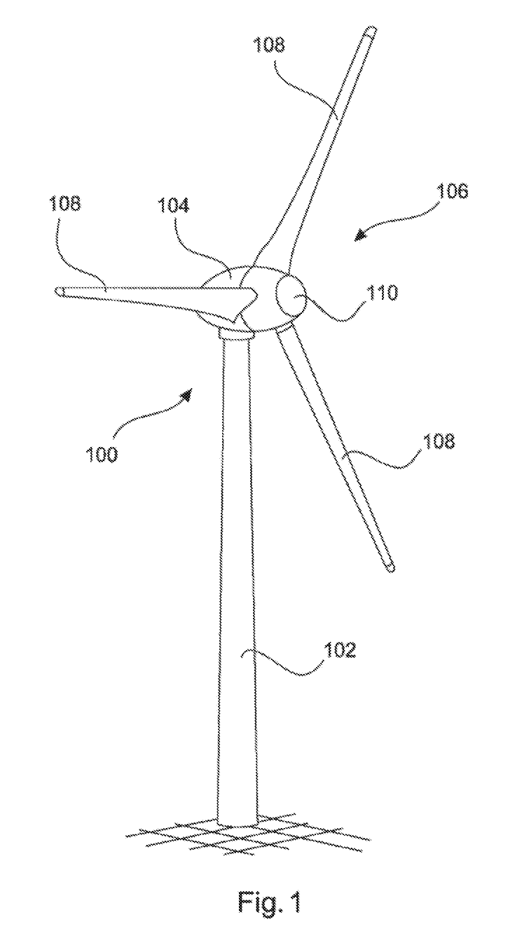

FIG. 1 shows a wind power installation in a perspective view.

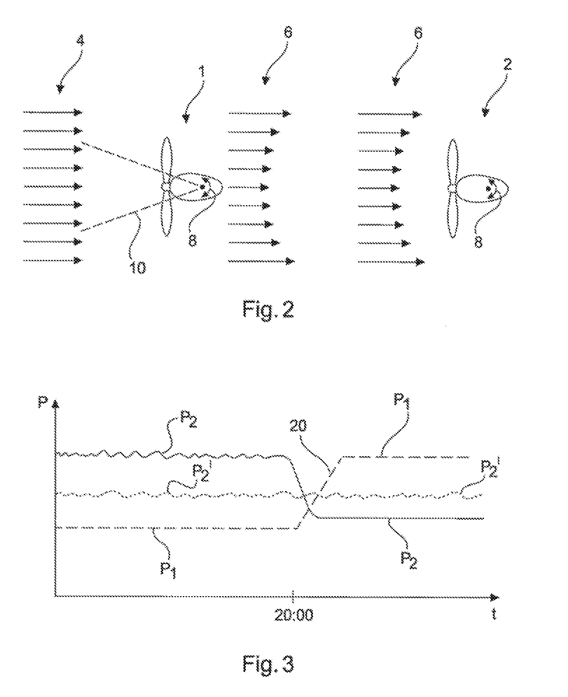

FIG. 2 illustrates a changed wind field in a schematic plan view of two wind power installations.

FIG. 3 schematically shows on the basis of a time diagram possible variations in the power of the two wind power installations as shown in FIG. 2.

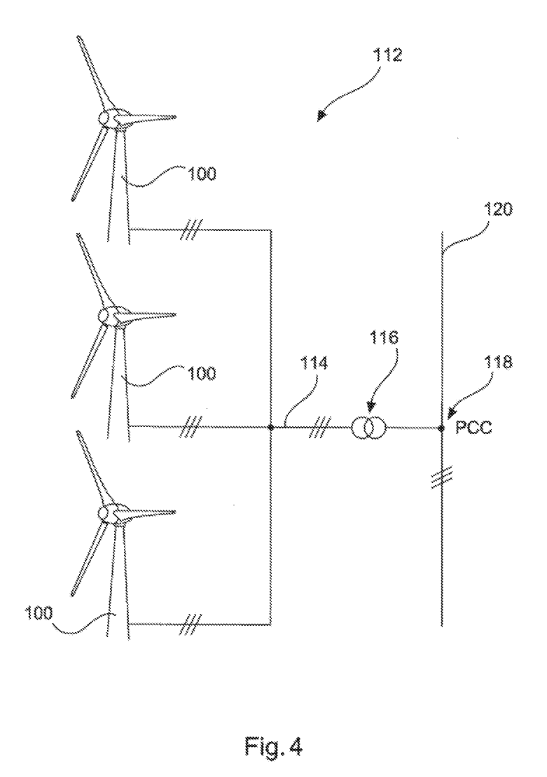

FIG. 4 shows a wind farm in a schematic representation.

### DETAILED DESCRIPTION

FIG. 1 shows a wind power installation 100 with a tower 102 and a nacelle 104. Arranged on the nacelle 104 is a rotor 106 with three rotor blades 108 and a spinner 110. During operation, the rotor 106 is set in a rotary motion by the wind, and thereby drives a generator in the nacelle 104.

FIG. 4 shows a wind farm 112 with, by way of example, three wind power installations 100, which may be the same or different. The three wind power installations 100 are consequently representative of essentially any number of wind power installations of a wind farm 112. The wind power installations 100 provide their power, to be specific in particular the electricity generated, by way of an electrical farm grid 114. In this case, the electricity or power respectively generated by the individual wind power installations 100 is added together and there is usually a transformer 116, which steps up the voltage in the farm in order then to feed into the supply grid 120 at the feed-in point 118, which is also referred to generally as the PCC. FIG. 2 is a simplified representation of a wind farm 112, which for example does not show any controller, although there is of course a controller. It is also possible, for example, for the farm grid 114 to be differently designed, in that, for example, there is also a transformer at the output of each wind power installation 100, to name just one other exemplary embodiment.

In FIG. 2, an arrangement of two wind power installations is represented in a very schematic plan view, to be specific a first wind power installation 1 and a second wind power installation 2, with the first wind power installation 1 being arranged on the windward side with respect to the second wind power installation 2, and correspondingly the second wind power installation 2 being arranged on the leeward side with respect to the first wind power installation. For the purposes of illustration, FIG. 2 shows an ideal wind field 4. It is, accordingly, intended to be illustrated by various arrows of the same length in the same direction that the wind is of the same strength and blows in the same direction. This idealized wind field consequently relates to the first wind power installation 1 or acts on the first wind power installation 1.

It is then assumed that, owing to the first wind power installation 1, the downwind wind field 6 is produced from this ideal wind field 4. For illustrative purposes, seen from the direction of the wind, this downwind wind field 6 is depicted downwind of the first wind power installation 1 and again directly upwind of the second wind power installation 2. To this extent, it is assumed here for the sake of simplicity that this wind field 6 no longer changes from this path. Although this is an idealized situation, it is sufficient for explaining the invention.

In any event, it is illustrated by arrows of different lengths in the downwind wind field 6 that the wind is then of different strengths. In this illustration of FIG. 2, effects of turbulence are ignored. It can consequently be seen that the ideal wind field 4 is weakened by the first wind power installation 1 in the region of the first wind power installation 1, and correspondingly acts in a weakened state on the second wind power installation 2.

In order to compensate for this weakening by which this second wind power installation 2 is affected, it is thus proposed to cut back the first wind power installation. As a result, the weakening of the downwind wind field 6 can be less pronounced, and in any event turbulence in the downwind wind field 6 can also be reduced, which is not shown in FIG. 2.

The first and second wind power installations 1, 2 are variable in their azimuth position 8, which is illustrated by a curved double-headed arrow in each case. The influence of the first wind power installation 1 on the downwind wind field 6 is in principle independent of the direction of the wind. Indeed, this changing of the downwind wind field only affects the second wind power installation 2 for wind directions that correspond approximately to that prevailing in FIG. 2. Small deviations from this wind direction can also still lead to an effect on the second wind power installation 2, and FIG. 2 shows for this an azimuth sector 10. If the wind direction is coming from a direction that lies within this azimuth sector 10 or if the azimuth position of the first wind power installation 1 correspondingly lies in this azimuth sector 10, cutting back of the first wind power installation is proposed in order to advantageously influence the downwind wind power installation 2.

If, however, the wind speed is outside this azimuth sector 10 or the first wind power installation 1 is outside this azimuth sector in its azimuth position, it is assumed that the first wind power installation 1 does not influence the second wind power installation 2, or not significantly. Correspondingly, it is then proposed not to cut back the first wind power installation.

Whether the wind direction lies in the azimuth sector 10 and whether the azimuth position of the first wind power installation 1 correspondingly lies in the azimuth sector 10, should coincide approximately, it being possible for there to be slight deviations, which may also be of a temporal nature. Practically, it is proposed to use the azimuth position of the first wind power installation as a criterion, since this is easy to record and can be easily available as information in the installation controller. The measurement or utilization of the wind direction may be unnecessary as a result.

FIG. 3 illustrates in a diagram three possible variations of the power that can be generated by two wind power installations, as shown and arranged for the sake of simplicity in FIG. 2. To this extent, it can be assumed for the purposes of representation that the first power P₁ is generated by the first wind power installation 1 according to FIG. 2 and the second power P₂ is generated by the second wind power installation 2 according to FIG. 2.

Also depicted in FIG. 3 is a power P′₂ that can in theory be generated by the second wind power installation 2 and would be likely if the wind power installation 1 were not cut back. The time t is plotted on the x axis of the diagram of FIG. 3, though absolute values do not matter. For example, the time of day of 20:00 hours, that is to say 08:00 hours in the evening, is depicted, because at that time a throttling of the power may be performed because of noise reduction regulations, serving here for purposes of illustration. The absolute values of the power P do not matter, and so the coordinate has no value for the power P. It can be assumed that the uppermost power curves shown lie, for example, just below the nominal power of the respective installations. For the sake of simplicity, two identical wind power installations with the same nominal power outputs may be taken as a basis here.

It can thus be seen from the first half of the diagram, that is to say before the depicted time of 20:00 hours, that the second wind power installation 2 is generating a comparatively high power P₂. The first wind power installation 1 has been cut back, and for this reason is only generating the lower power P₁. Without cutting back, the first wind power installation 1 can generate a similar amount of power as indicated there in the left-hand region by P₂. However, it is pointed out that this FIG. 3 is for illustrative purposes, and the proposed cutting back of the first wind power installation 1 may also be much less.

FIG. 3 thus shows that, by cutting back the first wind power installation 1 to the power value P₁, the second wind power installation 2 can generate more power, to be specific power according to P₂, than would be the case without cutting back the first wind power installation 1, that is to say more than is indicated by the value P′₂.

At around 08:00 hours in the evening, it is then assumed in the example shown that the second wind power installation 2 is to be reduced in its power generation, for example, to reduce noise. Correspondingly, the power P₂ of the second wind power installation 2 is cut back to this low value. It can be seen that this reduced power is lower than the power P′₂ that this second wind power installation 2 could generate if the first wind power installation 1 were not cut back. Consequently, then, that is to say after 08:00 hours in the evening, the second wind power installation 2 thus cannot in any case generate the power value that it could generate without cutting back the first wind power installation 1. It is correspondingly proposed not to cut back the first wind power installation 1, and correspondingly the power P₁ of the first wind power installation 1 can be raised to the higher value after 08:00 hours in the evening that is shown. It can also be seen that departing from the cutting back of the first wind power installation 1 before 08:00 hours in the evening proceeds to the not cut-back power value P₁ after 08:00 hours in the evening with a flank 20, for which a gradient may be prescribed.

FIG. 3 consequently illustrates possibilities and effects of cutting back or not cutting back with respect to power. The illustration with respect to cutting back the power can also be transferred analogously to other operating states, in particular the rotational speed.

At least according to some embodiments, wind power installations are not stopped within certain sectors. Since at many locations this is not absolutely required, and the installations instead can continue to be operated with a reduced maximum output or a greater minimum blade angle, a sectorial cutting back has been proposed instead of a sectorial shutting down. Furthermore, a number of sectors, in particular eight sectors, are proposed for cutting back and can be provided.

In addition, a sectorial shutting down may also be performed. This is proposed in particular as soon as a minimum blade angle of more than a predetermined value, in particular more than 45 degrees, is parameterized in the controller. Such a minimum blade angle for shutting down is preferably set at 90 degrees.

According to at least one embodiment, the following is also proposed.

The real power of a wind power installation can be cut back according to the nacelle alignment and the wind speed in order to reduce turbulence, and resultant loads, on following wind power installations in a wind farm, known as the wake effect. The wind power installation may, for example, be cut back in that, according to choice, the maximum real power is limited and/or the minimum blade angle is defined.

Up to eight sectors, which may overlap in any way desired, may be defined in the controller of the wind power installation for the sectorial cutting back. In this case, a start angle and an end angle must be respectively fixed for each sector, it being possible for the direction of North to correspond to the value 0 degrees. A minimum wind speed and a maximum wind speed may also be defined for each individual sector.

Then, according to choice, the maximum real power and/or the minimum blade angle may be specified for each sector defined in this way. If sectors overlap, the least maximum real power and the greatest minimum blade angle are determined and adopted.

In order to prevent jumps in power, a gradient may be fixed for increasing and reducing the maximum real power. According to one embodiment, this value applies to all the sectors. The changing of the blade angle is for example limited to a maximum of 0.5 of a degree per second.

If the nacelle is aligned within one of the defined sectors and the mean value of the wind speed over a period of time of one minute lies within the associated wind speed range, according to one embodiment the maximum real power and the minimum blade angle are adopted by the controller. The wind power installation is accordingly cut back. If the nacelle leaves the sector or if the wind speed lies outside the prescribed range, the cutting back is only discontinued after the elapse of a delay time of in particular 60 seconds.

In this way it is prevented that the wind power installation continually changes between normal operation and cut-back operation, for example, in gusty wind conditions.

If a minimum blade angle of more than 45 degrees has been prescribed, according to one embodiment the wind power installation stops, and starts again at the earliest after the elapse of a delay time of 10 minutes.

If the wind power installation is cut back or stopped by the sectorial cutting back described, a corresponding message is generated. This message is stored in a wind farm server. In this way it is possible to verify at any time in which time periods the wind power installation was operated in a cut-back state or was stopped.

The settings of the sectorial cutting back can be viewed by way of remote monitoring.

If a sectorial cutting back is commenced or discontinued over a gradient, this may be for a change in power of for example 50 kW/s to 500 kW/s.

1. A method for operating a wind farm having a plurality of wind power installations including a first wind power installation and a second wind power installation, comprising:
cutting back the first wind power installation based on an azimuth position of the first wind power installation, the first and second wind power installations are in a proximity of each other such that, depending on a direction of wind, the first and second wind power installations influence each other by way of the wind, each wind power installation of the first and second wind power installations respectively having a generator, a nacelle with an aerodynamic rotor having one or more rotor blades, each wind power installation has a variable azimuth position; and
in response to the cutting back of the first wind power installation, positively influencing the wind reaching the second wind power installation arranged, in the wind farm, downwind from the first wind power installation.

2. The method as claimed in claim 1, wherein the cutting back of the first wind power installation includes making at least one operational change from a plurality of operational changes including:
reducing the generator output;
prescribing a maximum generator output;
reducing the rotor speed;
prescribing a maximum rotor speed;
increasing the blade angle; and
prescribing a minimum blade angle.

3. The method as claimed in claim 1, wherein cutting back the first wind power installation based on the azimuth position includes:
setting an azimuth sector; and
performing the cutting back when the first wind power installation has an azimuth position within the azimuth sector.

4. The method as claimed in claim 1, comprising:
determining that a criterion for the cutting back is no longer applicable;
waiting for a predetermined delay time; and
discontinuing the cutting back after the predetermined delay time elapse.

5. The method as claimed in claim 1, comprising:
cutting back the first wind power installation based on at least one further criterion from a plurality of further criteria including:
wind speed; and
other wind conditions.

6. The method as claimed in claim 1, comprising:
cutting back the first wind power installation based on an azimuth sector of a plurality of azimuth sectors of the first wind power installation.

7. The method as claimed in claim 6, wherein the cutting back based on the azimuth position or the azimuth sector is performed such that:
the second wind power installation arranged downwind of the first wind power installation is exposed to more wind power than without the cutting back of the first wind power installation.

8. The method as claimed in claim 1, comprising:
when the second wind power installation is operating in a reduced-noise mode, refraining from the cutting back of the first wind power installation or cutting back the first wind power installation to a lesser degree.

9. The method as claimed in claim 4, wherein at least one of the cutting back of the first wind power installation or the discontinuing of the cutting back first wind power installation is performed with a gradient.

10. A first wind power installation operated in a wind farm, comprising:
a generator;
a nacelle with an aerodynamic rotor having one or more rotor blades; and
a controller configured to cut back the first wind power installation based on an azimuth position of the first wind power installation to positively influence the reaching a second wind power installation arranged, in the wind farm, downwind from the first wind power installation.

11. A wind farm comprising a plurality of wind power installations including the first wind power installation as claimed in claim 10 and the second wind power installation.

12. The method as claimed in claim 8, comprising:
when the second wind power installation is operating in a throttled mode, refraining from the cutting back of the first wind power installation or cutting back the first wind power installation to a lesser degree.
